(19) United States
(12) Patent Application Publication
(10) Pub. No.: US 2022/0371380 A1
(43) Pub. Date: Nov. 24, 2022

(54) TREAD FOR A TIRE

(71) Applicant: The Goodyear Tire & Rubber Company, Akron, OH (US)

(72) Inventors: Arnaud Caron, Signeulx (BE); Ananth Bhagavathapuram Srisailapathy, Ettelbruck (LU); Tibor Fülöp, Erpeldange-Wiltz (LU)

(21) Appl. No.: 17/326,476

(22) Filed: May 21, 2021

(51) Int. Cl. B60C 11/12; B60C 11/03

(52) U.S. Cl. CPC B60C 11/1236; B60C 11/0302

(57) ABSTRACT

A tire tread includes a middle rib formed by two circumferential main grooves extending along a tire circumferential direction, a first shoulder rib disposed axially outward from the center rib and one of the circumferential main grooves, and a second shoulder rib disposed axially outward from the center rib and the other of the two circumferential main grooves. The middle rib has a repeated group of three sipes: a first sipe being inclined radially inward a first angle relative to a radial direction, a second sipe being inclined radially inward a second angle relative to the radial direction, and a third sipe being inclined radially inward a third angle relative to the radial direction. The second angle is between −0.5 degrees and +0.5 degrees. The first and third angles are oppositely radially inclined to each other and the radial direction.

### FIELD OF THE INVENTION

The present patent application is directed to a tire and, in particular, a tire tread with narrow grooves in blocks or ribs of the tire tread.

### BACKGROUND OF THE INVENTION

Conventionally, tread design optimization methods tend to impact wet and dry braking and traction in opposite directions. Decoupling/adding cuts may generally improve wet braking distance while higher stiffness/higher contact area may improve dry braking distance. A method for eliminating this trade-off and improving both wet and dry braking and traction would be desirable. A tread block design in accordance with the present invention may improve wet and dry braking distance and traction with tilted sipes combined with a chamfer.

### SUMMARY OF THE INVENTION

A first tire tread in accordance with the present invention includes a middle rib formed by two circumferential main grooves extending along a tire circumferential direction, a first shoulder rib disposed axially outward from the center rib and one of the circumferential main grooves, and a second shoulder rib disposed axially outward from the center rib and the other of the two circumferential main grooves. The middle rib has a repeated group of three sipes: a first sipe being inclined radially inward a first angle relative to a radial direction, a second sipe being inclined radially inward a second angle relative to the radial direction, and a third sipe being inclined radially inward a third angle relative to the radial direction. The second angle is between −0.5 degrees and +0.5 degrees. The first and third angles are oppositely radially inclined to each other and the radial direction.

According to another aspect of the first tire tread, the first and third angles are equal and oppositely radially inclined to each other and the radial direction.

According to still another aspect of the first tire tread, the first sipe is radially inwardly and angled circumferentially away from the second sipe.

According to yet another aspect of the first tire tread, the third sipe is radially inwardly angled circumferentially away from the second sipe.

According to still another aspect of the first tire tread, the first shoulder rib has a second repeated group of three sipes: a first sipe being inclined radially inward a first angle relative to a radial direction, a second sipe being inclined radially inward a second angle relative to the radial direction, and a third sipe being inclined radially inward a third angle relative to the radial direction. The second angle are between −0.5 degrees and +0.5 degrees. The first and third angles are oppositely radially inclined to each other and the radial direction.

According to yet another aspect of the first tire tread, the second shoulder rib has a third repeated group of three sipes: a first sipe being inclined radially inward a first angle relative to a radial direction, a second sipe being inclined radially inward a second angle relative to the radial direction, and a third sipe being inclined radially inward a third angle relative to the radial direction. The second angle is between −0.5 degrees and +0.5 degrees. The first and third angles are oppositely radially inclined to each other and the radial direction.

According to still another aspect of the first tire tread, the first group, the second group, and the third group each have equal first, second, and third angles.

According to yet another aspect of the first tire tread, the first group and the third group each have equal first, second, and third angles.

According to still another aspect of the first tire tread, the first group and the second group each have equal first, second, and third angles.

According to yet another aspect of the first tire tread, the first group and the third group each have unequal first and third angles.

A second tire tread includes an intermediate rib formed by two circumferential main grooves extending along a tire circumferential direction, a first shoulder rib disposed axially outward from the center rib and one of the circumferential main grooves, and a second shoulder rib disposed axially outward from the center rib and the other of the two circumferential main grooves. The middle rib has a repeated group of three sipes: a first sipe being inclined radially inward a first angle relative to a radial direction, a second sipe being inclined radially inward a second angle relative to the radial direction, and a third sipe being inclined radially inward a third angle relative to the radial direction.

According to another aspect of the second tire tread, the first angle is between +10 degrees and +30 degrees.

According to still another aspect of the second tire tread, the second angle is between −0.5 degrees and +0.5 degrees.

According to yet another aspect of the second tire tread, the third angle is between −10 degrees and −30 degrees.

According to still another aspect of the second tire tread, the first angle is between +17 degrees and +23 degrees.

According to yet another aspect of the second tire tread, the second angle is between −0.5 degrees and +0.5 degrees.

According to still another aspect of the second tire tread, the third angle is between −17 degrees and −23 degrees.

According to yet another aspect of the second tire tread, the first angle is between +19.5 degrees and +20.5 degrees.

According to still another aspect of the second tire tread, the second angle is between −0.5 degrees and +0.5 degrees.

According to yet another aspect of the second tire tread, the third angle is between−19.5 degrees and −20.5 degrees.

### Definitions

As used herein and in the claims:

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane EP of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65 degrees and 90 degrees with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The accompanying drawings, which are incorporated in, and constitute a part of, this specification, illustrate examples of the present invention and, together with a general description of the present invention given above, and the detailed description given below, serve to explain the present invention.

FIG. 1 is a schematic orthogonal view of a tire tread in accordance with the present invention;

FIG. 2 is a schematic sectional view of part of the tire tread of FIG. 1;

FIG. 3 is another schematic sectional view of the tire tread of FIG. 1 under acceleration; and

FIG. 4 is still another schematic sectional view of the tire tread of FIG. 1 under braking.

### DETAILED DESCRIPTION OF EXAMPLES OF THE PRESENT INVENTION

This description is made for the purpose of illustrating the general principles of the present invention and should not be understood in a limiting sense. The scope of the present invention is best determined by reference to the appended claims. The reference numerals as depicted in the drawings are the same as those referred to in this specification. Any further structural limitations of the example tire and tread may be specified in U.S. Pat. No. 9,174,495, herein incorporated by reference in its entirety.

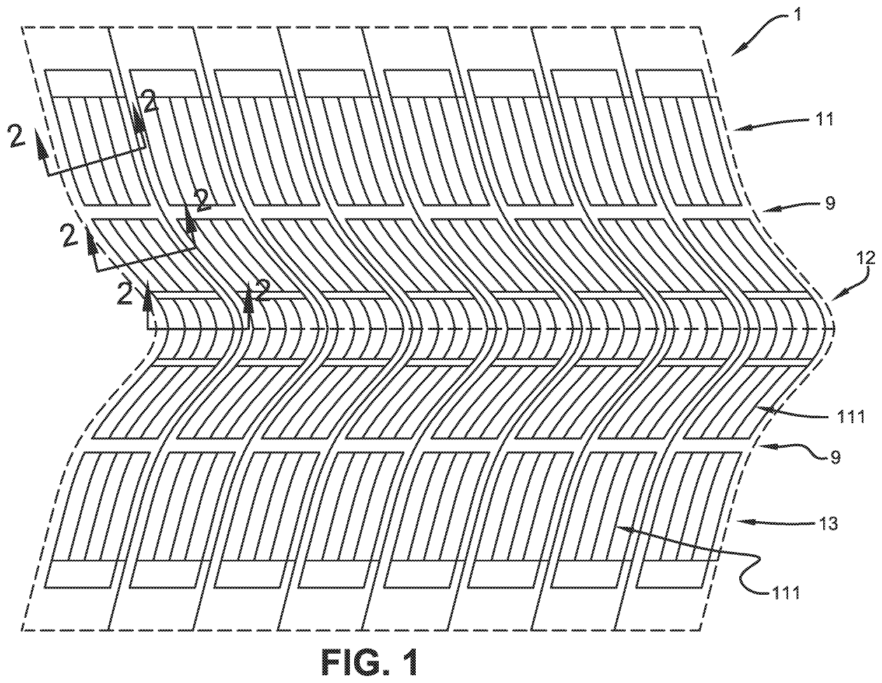

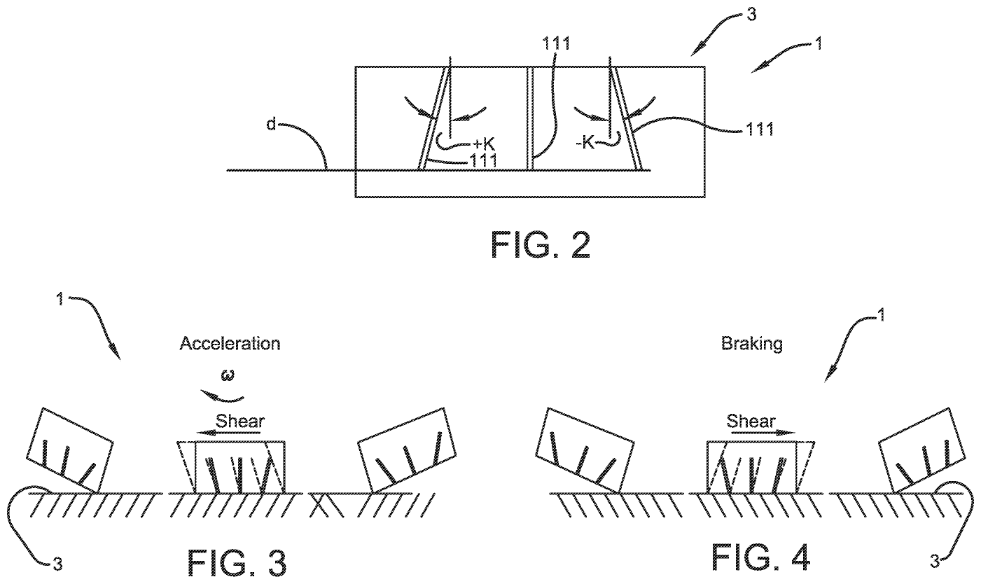

FIGS. 1-4 show an example pneumatic or non-pneumatic tire tread 1 having a contact surface 3, such as a road, and a first circumferential shoulder rib 11, a second circumferential center rib 12, and a third circumferential shoulder 13, each separated axially by a circumferential groove 9. The first rib 11, the second rib 12, and the third rib 13 may have axially extending sipes 111. The sipes 111 may be axially extending, angled in the direction of rotation, or angled opposite the direction of rotation (FIG. 2). The sipes 111 may have a circumferential thickness between 0.4 mm and 2.0 mm. The sipes 111 may have axial lengths between 15.0 mm and 30.0 mm, or 17.0 mm and 26.0 mm, or between 21.0 mm and 23.0 mm, or 21.5 mm. The sipes 111 may have radial depths between 6.0 mm and 12.0 mm.

As shown in FIG. 2, a group of three of the sipes 111 may extend directly radially inward (middle sipe), radially inward (and circumferentially) at an angle +k to a radial depth d from the contact surface 3 (left sipe), and radially inward (and circumferentially) at an opposite angle −k to a radial depth d from the contact surface 3 (right sipe). The value of angle k may be between +10 degrees and +30 degrees, or between +17 degrees and +23 degrees, or +20 degrees, and correspondingly between −10 degrees and −30 degrees, or between −17 degrees and −23 degrees, or −20 degrees. The radial depth d may be between 5.0 mm and 7.0 mm, or 5.5 mm and 6.5 mm, or 6.0 mm.

Conventionally, tread design optimization for braking tends to impact wet and dry braking in opposite directions. A general trend is that lower tread stiffness improves wet braking, but penalizes dry braking. The above grouping of sipes 111 may allow optimization of wet braking without the trade-off in dry braking. FIG. 3 illustrates an example of the sipes 111 operating under accelerating conditions. FIG. 4 illustrates an example of the sipes 111 operating under braking conditions.

In accordance with the present invention, this grouping of sipes 111 may mitigate block stiffness locally and correspondingly enable block deformation locally. As seen FIGS. 3-4, the trailing edges at each sipe 111 (right edge in FIG. 3 and left edge in FIG. 4) may open and thereby increase the capacity to retain the snow during both acceleration and braking. Traction in both cases is thereby enhanced.

The present invention has been described with reference to the above examples. Modifications and alterations may occur to others upon reading and understanding of this specification. The specification is intended to include all such modifications and alterations in so far as they come within the scope of the appended claims or the equivalents thereof.

1. A tire tread comprising:
a middle rib formed by two circumferential main grooves extending along a tire circumferential direction;
a first shoulder rib disposed axially outward from the center rib and one of the circumferential main grooves; and
a second shoulder rib disposed axially outward from the center rib and the other of the two circumferential main grooves,
the middle rib having a repeated group of three sipes: a first sipe being inclined radially inward a first angle relative to a radial direction, a second sipe being inclined radially inward a second angle relative to the radial direction, and a third sipe being inclined radially inward a third angle relative to the radial direction,
the second angle being between −0.5 degrees and +0.5 degrees, the first and third angles being oppositely radially inclined to each other and the radial direction.

2. The tire tread as set forth in claim 1 wherein the first and third angles are equal and oppositely radially inclined to each other and the radial direction.

3. The tire tread as set forth in claim 1 wherein the first sipe is inwardly angled circumferentially away from the second sipe.

4. The tire tread as set forth in claim 1 wherein the third sipe is inwardly angled circumferentially away from the second sipe.

5. The tire tread as set forth in claim 1 wherein the first shoulder rib has a second repeated group of three sipes: a first sipe being inclined radially inward a first angle relative to a radial direction, a second sipe being inclined radially inward a second angle relative to the radial direction, and a third sipe being inclined radially inward a third angle relative to the radial direction, the second angle being between −0.5 degrees and +0.5 degrees, the first and third angles being oppositely radially inclined to each other and the radial direction.

6. The tire tread as set forth in claim 5 wherein the second shoulder rib has a third repeated group of three sipes: a first sipe being inclined radially inward a first angle relative to a radial direction, a second sipe being inclined radially inward a second angle relative to the radial direction, and a third sipe being inclined radially inward a third angle relative to the radial direction, the second angle being between −0.5 degrees and +0.5 degrees, the first and third angles being oppositely radially inclined to each other and the radial direction.

7. The tire tread as set forth in claim 6 wherein the first group, the second group, and the third group each have equal first, second, and third angles.

8. The tire tread as set forth in claim 6 wherein the first group and the third group each have equal first, second, and third angles.

9. The tire tread as set forth in claim 6 wherein the first group and the second group each have equal first, second, and third angles.

10. The tire tread as set forth in claim 6 wherein the first group and the third group each have unequal first and third angles.

11. A tire tread comprising:
an intermediate rib formed by two circumferential main grooves extending along a tire circumferential direction;
a first shoulder rib disposed axially outward from the center rib and one of the circumferential main grooves; and
a second shoulder rib disposed axially outward from the center rib and the other of the two circumferential main grooves,
the middle rib having a repeated group of three sipes: a first sipe being inclined radially inward a first angle relative to a radial direction, a second sipe being inclined radially inward a second angle relative to the radial direction, and a third sipe being inclined radially inward a third angle relative to the radial direction.

12. The tire tread as set forth in claim 11 wherein the first angle is between +10 degrees and +30 degrees.

13. The tire tread as set forth in claim 12 wherein the second angle is between −0.5 degrees and +0.5 degrees.

14. The tire tread as set forth in claim 13 wherein the third angle is between −10 degrees and −30 degrees.

15. The tire tread as set forth in claim 11 wherein the first angle is between +17 degrees and +23 degrees.

16. The tire tread as set forth in claim 15 wherein the second angle is between −0.5 degrees and +0.5 degrees.

17. The tire tread as set forth in claim 16 wherein the third angle is between −17 degrees and −23 degrees.

18. The tire tread as set forth in claim 11 wherein the first angle is between +19.5 degrees and +20.5 degrees.

19. The tire tread as set forth in claim 18 wherein the second angle is between −0.5 degrees and +0.5 degrees.

20. The tire tread as set forth in claim 19 wherein the third angle is between −19.5 degrees and −20.5 degrees.
